(19) United States
(12) Patent Application Publication
(10) Pub. No.: US 2011/0317542 A1
(43) Pub. Date: Dec. 29, 2011

(54) Method and Apparatus for Diversity Transmission Scheme in Single-Carrier FDMA Systems

(75) Inventors: Tyler A. BROWN, Mundelein, IL (US); Xiangyang Zhuang, Lake Zurich, IL (US)

(73) Assignee: MOTOROLA, INC., Schaumburg, IL (US)

(21) Appl. No.: 12/824,083

(22) Filed: Jun. 25, 2010

(51) Int. Cl. H04J 11/00

(52) U.S. Cl. 370/210

(57) ABSTRACT

The disclosure relates to transmission of user data over multiple transmission layers in a wireless communication system with single-carrier orthogonal frequency division multiple access. A wireless terminal performs transform precoding on a vector of digital modulation symbols and the resulting complex-valued symbols are mapped to frequency/time/space resources. The digital modulation symbols are reordered, modified by a setting of complex-valued functions, and transform precoded. The resulting second set of complex-valued symbols are transform precoded and mapped to frequency/time/space resources.

### FIELD OF THE DISCLOSURE

The present disclosure relates generally to wireless communications and more particularly to spatial diversity transmission in single carrier FDMA systems.

### BACKGROUND

Single-carrier Frequency Division Multiple Access (SC-FDMA) is a multiplexing scheme used in wireless communication systems that first transform precodes, typically with the discrete Fourier transform (DFT), a set of modulation symbols, to generate a set of frequency domain samples which are then mapped to a set of subcarriers in a SC-FDMA symbol period. An inverse discrete Fourier transform (IDFT) will then be applied onto the set of frequency domain samples to generate a set of time samples which have the desirable property of a low peak-to-average power ratio. Transmit waveforms with low peak-to-average power ratios can be amplified with highly efficient power amplifiers that require minimum bias current and therefore SC-FDMA is a popular choice for mobile wireless systems such 3GPP LTE Releases 8,9, and 10.

Modern wireless communication systems often employ multiple antennas at both the transmitter and receiver for either transmission/reception diversity or spatial multiplexing of multiple user data streams. Spatial multiplexing is advantageous when propagation conditions include scattering and reflections of a transmitted signal thereby causing multiple paths between transmitter and receiver. With appropriate transmission techniques, different user data streams can be directed along each path, the maximum number of streams being equal to the minimum of the number of transmit and receive antennas. A common transmission technique used to enable spatial multiplexing is spatial precoding. In spatial precoding two or more transmission layers are formed from the coded modulation symbols of two or more user data streams. A typical example is when the coded symbols of the first user data stream are sent on the first transmission layer and the coded symbols of the second user data stream are sent on the second transmission layer. At each SC-FDMA symbol, the frequency domain samples corresponding to the two data streams are multiplied by a precoding matrix. The components of the resulting signals are transmitted on a set of antennas, each component corresponding to a different transmit antenna. Note that if the precoding matrix is not square, the number of transmission layers and number of transmission antennas will not be equal. The performance of spatial multiplexing is heavily dependent on how the precoding matrix is chosen. In open loop schemes, it may be a constant, while in closed-loop schemes the user may feed back to the transmitter either a recommended precoding matrix as in the downlink of LTE or may give an explicit instruction to the transmitter on which precoding matrix to use, as in the uplink of 3GPP LTE Release 10. Regardless of how the precoding matrix is determined, spatial precoding of, for example two transmission layers, allows two user data streams to be transmitted over the channel instead of one.

However spatial multiplexing is not suited to all transmission scenarios. One such scenario is the transmission of fixed-payload, low-rate data, possibly in parallel with multiple spatially multiplexed data streams. This scenario occurs in the uplink of 3GPP LTE Release 10 when the so-called UCI (user control information) symbols are multiplexed with user data onto the physical uplink shared channel (PUSCH) and the mobile station, or UE, is transmitting in spatial multiplexing mode. Because the low-rate payload in this scenario is fixed, spatial multiplexing mode of transmission, which targets high spectral efficiency, may not be that helpful for the UCI payload which prefers robustness. The other option is to generate twice the number of coded symbols and transmit half the symbols on each layer. This offers some spatial diversity since the fading on the layers will be at east partially uncorrelated. However the diversity gain of this scheme is limited by the interference between symbol streams, termed inter-layer interference, observed at the receiver.

Therefore a need exists for a single-carrier FDMA transmission scheme that provides transmit spatial diversity across multiple transmission layers for one type of information symbol while still providing spatial multiplexing across the multiple transmission layers for a different type of information symbol.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a wireless communication system according to a possible embodiment;

FIG. 2 illustrates space-time transform precoding according to a possible embodiment.

FIG. 3 illustrates reordering and symbol modification according to a possible embodiment;

FIG. 4 illustrates the mapping of digital modulation symbols to time and layers according to a possible embodiment

FIG. 5 illustrates the mapping of digital modulation symbols to time and layers according to a second possible embodiment

### DETAILED DESCRIPTION

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

In the following description, the terms base-station, base unit, eNB, transmitter are used interchangeably to represent a point in a wireless that is transmitting data to another receiving device. The terms receiver, wireless device, UE, are used interchangeably to represent a device receiving data and communicating with a transmitting device.

The present disclosure comprises a variety of embodiments, such as a method, an apparatus, and an electronic device, and other embodiments that relate to the basic concepts of the disclosure. The electronic device may be any manner of computer, mobile device, or wireless communication device.

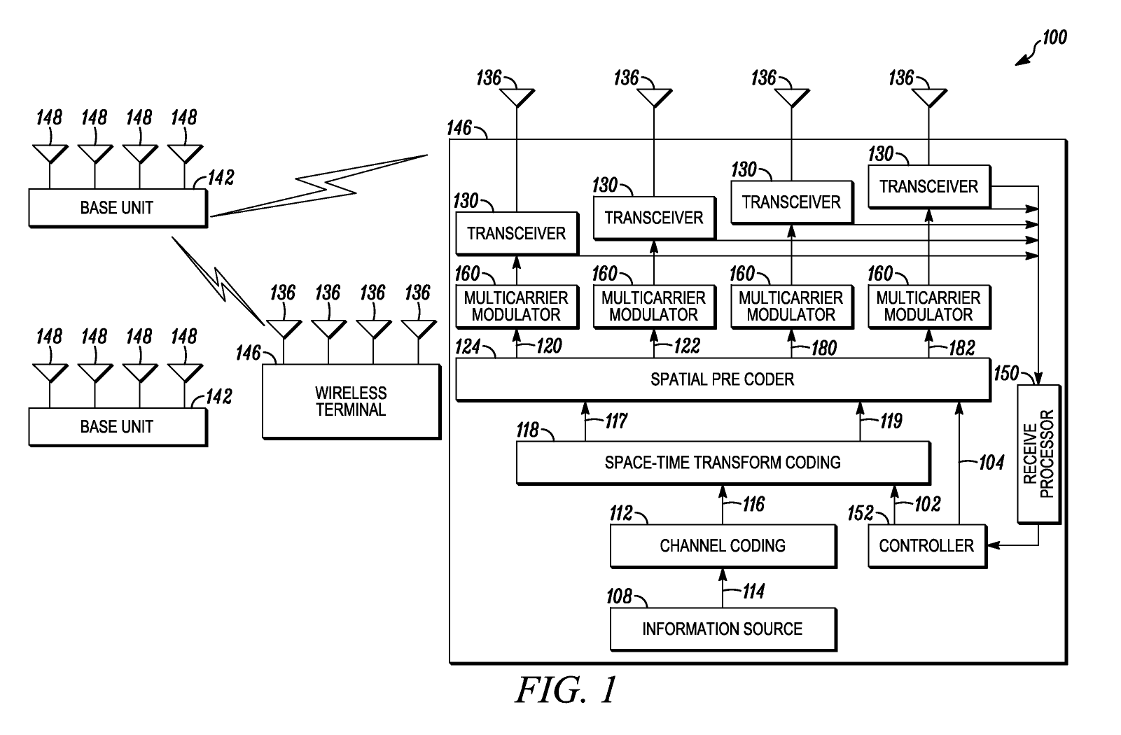

FIG. 1 block diagram of a system 100 for communicating data over multiple transmission layers with SC-FDMA in accordance with an exemplary embodiment of the present invention. The wireless terminal 146 can consist of a plurality of antennas 136 coupled to transceivers 130. The wireless terminal 146 can also include a receiver 150 coupled to the transceivers 130 and 131 and also coupled to a controller 152. The receiver 150 may receive control messages from the base unit 142 which are then passed to the controller 152. The controller 152 can be configured to control operations of the wireless terminal 146. The information source 108 generates data to be transmitted from the wireless terminal to the base unit. The information source 108 delivers vectors of information bits 114. The controller 152 also outputs control information signal 102 to the space-time transform coder 118. The control information signal can be information relating to which transmission layers will be used to carry coded information symbols as mapped by the space-time transform coder 116. Control information 104 related to the characteristics of the transmission link between the base unit 142 and the wireless unit 146 may be a precoding matrix to be applied by the spatial precoder 124.

The spatial channel coder 112 operates on the information bits 114 to generate vectors of digital modulation symbols 116. The channel coder 112 adds redundancy to the information bits of information bits vectors 114 in order to aid in the correction of errors which occur in the transmission link between wireless terminal 146 and base unit 148 to be corrected by the receiver in the base unit. The vectors of digital modulation symbols 116 may be fed to space-time transform coder 118 which generates blocks of complex-valued symbols 117 and 119 with each block corresponding to a transmission layer.

The blocks of complex-valued symbols 117 and 119 are then fed to the spatial precoder 124 which can generate the inputs to the wireless terminal antennas 136 through the transceivers 130. Spatial precoding 124 can be performed with a precoding matrix which is used to form multiple weighted-combinations of the transmitter outputs. The weighted combinations are then applied to multicarrier modulators 160 which modulates each input symbol to equally-spaced subcarriers.

One skilled in the art can recognize that while the embodiment of the wireless terminal 146 described has two transmission layers of complex-valued symbols 117 and 119 and four transmit antennas on the wireless terminal 136, other embodiments may have any number of transmit antennas and any number of layers as long as the minimum of the number of transmit antennas 136 and the number of receive antennas is greater than or equal to the number of transmission layers.

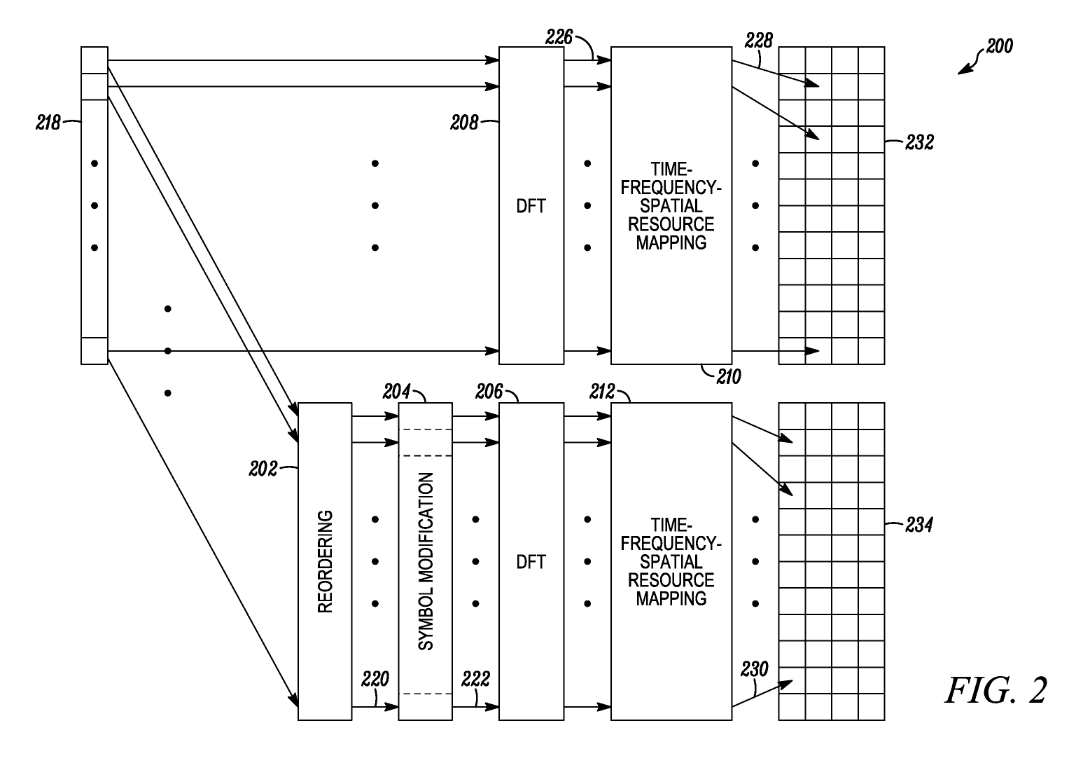

FIG. 2 illustrates one embodiment of the space time transform coder 118. According to this aspect of the disclosure, a vector of digital modulation symbols 218 is transformed by Discrete Fourier Transform (DFT) 208 to generate a set of complex-valued modulation symbols 226. The DFT is defined by the equation

$${x}_{n} = {å}_{k = 0}^{N - 1} {s}_{k} {e}^{- j2 pkn / N}$$

where s= [symbol] ₀ s₁ L s_{N-1} [symbol] is the vector of digital modulation symbols and x= [symbol] ₀x₁ L x_{N-1} [symbol] is the vector of complex-value symbols and N is length of each of these vectors. The notation [symbol] indicates matrix transposition. The DFT modulates a set of transform codes, represented as column vectors of length-N with the symbols of its input vector s . The transform code corresponding to the n th symbol is the vector [symbol] e^{j2pn/N} L e^{j2pn(N-1)/N} [symbol] . Note that if a second source of user data is to be transmitted, the vector s may contain both the low-rate control information and the user data multiplexed. The complex-modulation symbols 226 are mapped to a set of uplink resources consisting of a set of subcarriers, an SC-FDMA time period, and a spatial layer by the time/frequency/space resource mapper 210. The time/frequency mapper 210 maps N input symbols xₒ,x₁,L ,x_{N-1} onto a set of subcarriers, an SC-FDMA symbol interval, and the second transmission layer. Specifically, the complex-valued symbols xₒ,x₁,L ,x_{N-1} are mapped to subcarriersS₀,S₁,L, S_{N-1}, SC-FDMA time periods [symbol] ₀, t₀+T_{sc-ofdm} [symbol] , and spatial transmission layers L₁. Here is the time duration of an SC-OFDM symbol. An example of subcarrier mapping is localized mapping which maps modulation symbol n to the n₀+n subcarrier. A second example, based on distributed mapping, maps modulation symbol n to subcarrier n₀+N_{Dist}n where N_{Dist} is a positive integer greater than 1 and n₀ is a fixed subcarrier offset.

The vector of digital modulation symbols 218 is also fed to a reordering block that permutes the order of the digital modulation symbols within the vector. The permuted vector 220 is then fed to a symbol modification stage 204 which operates on each of the digital modulation symbols to generate a second vector of digital modulation symbols 222. The symbols modification stage is defined by the N functions f₀,f₁L,f_{N-1} each of which map complex numbers to complex numbers such that the nth element of 222 has the value fₙ(sₙ). An example of a symbol modification stage is one which outputs the complex conjugate of its input and is therefore defined by the functions fₙ(s)=s*, n=0,1,L,N−1. Another example of a symbol modification stage is one which rotates its n th input symbol by a phase of αₙ and is therefore defined by fₙ(s)=e^{jα}^{ₙ}s, n=0,1,L,N−1. The symbol modification stage can also not modify the symbols at all: fₙ(s)=s, n=0,1,L,N−1

The second vector of complex-valued modulation symbols 222 is then transformed by DFT 206 whose operation is the same as described above for DFT 208. The transformed set of complex-valued modulation symbols is then mapped to a second set of time/frequency resources 234 to a second transmission layer in a manner analogous to the mapping of the complex modulation symbols 226 described above. The SC-FDMA time interval [symbol] ₁, t₁+T_{sc-ofdm})to which the second vector of complex-valued modulation symbols are mapped can be the same or different than the SC-FDMA time interval, [symbol] ₀, t₀+T_{sc-ofdm} [symbol] ), to which the first vector of complex-valued modulation symbols are mapped.

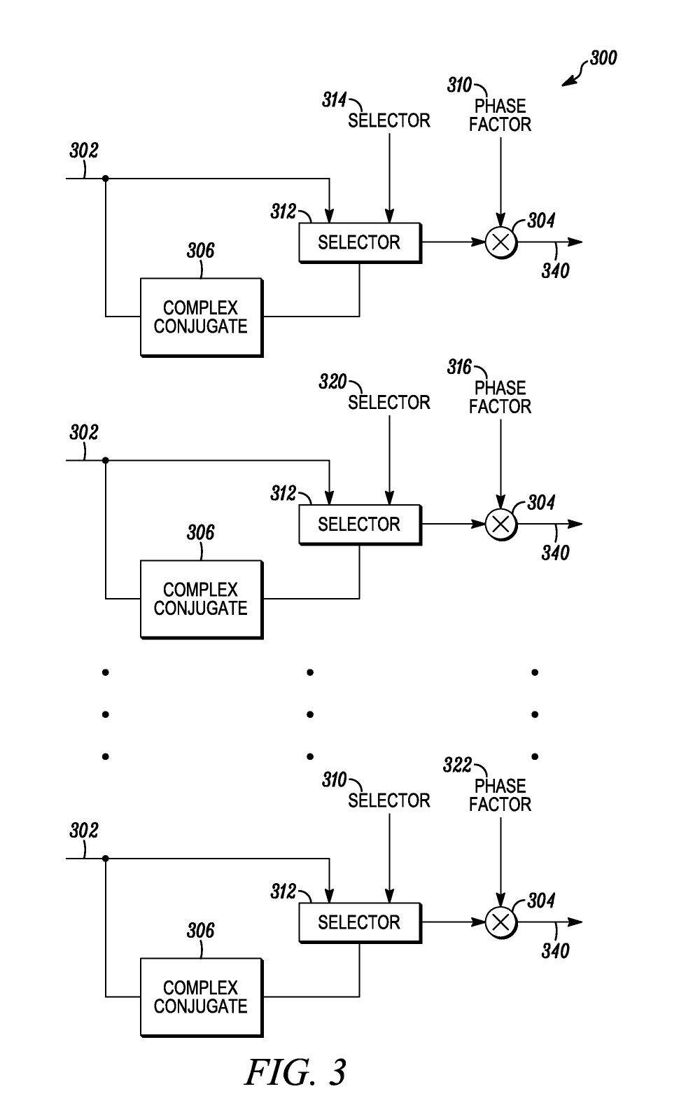

FIG. 3 illustrates an embodiment of the symbol modification stage 204. The reordered digital modulation symbols 302 are fed to complex conjugation blocks 306 which, along with the original modulation symbols 302, are fed to selectors 312. The selectors output either the modulation symbol or its complex conjugate depending on the selector inputs 314, 320, and 310. For example the selector may output the modulation symbols 302 if its selection input is ‘0’ and the complex conjugate of the modulation symbol if the its selection input is ‘1’. The selection inputs can be set at the time of manufacturer or can be programmable. They can also be determined from control messages sent from the base station. The selector outputs are rotated by phase factors 310, 316, and 322 in the multipliers 304 to yield modified complex modulation symbols 340. The phase factors applied to the set of selector outputs are complex numbers of the form e^{jα}^{ₙ}, n=0,1,L,N−1 where 0£ αₙ<2 p.

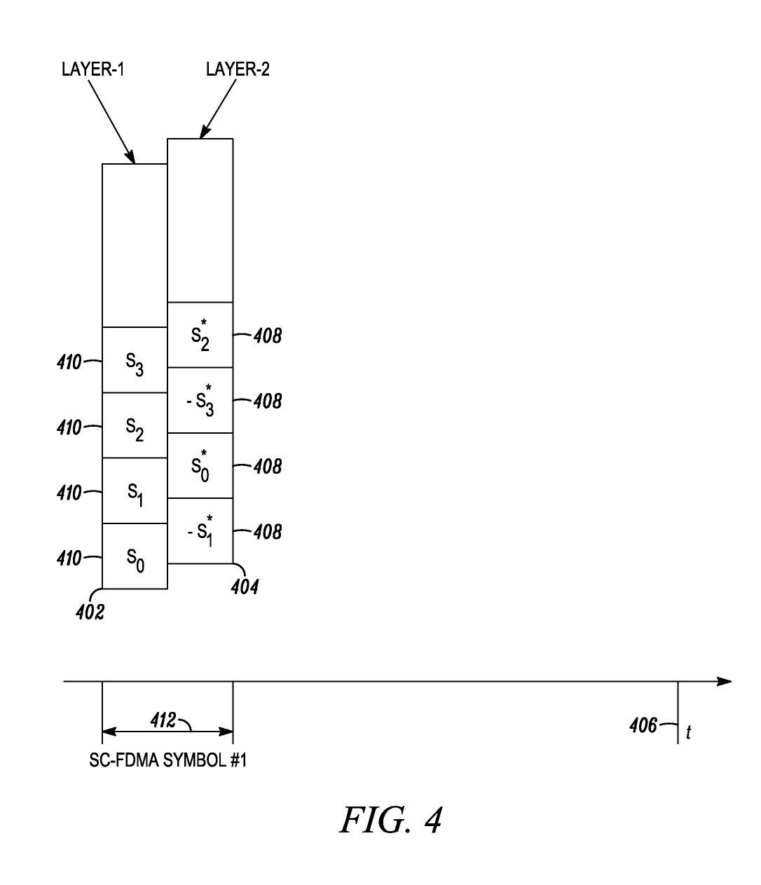

FIG. 4 illustrates the mapping of digital modulation symbols 218 to complex-valued symbols, SC-FDMA symbol intervals, and spatial layers for one embodiment of the disclosure. In this embodiment the reordering performed in 202 consists of taking pairs of digital modulation symbols with indices k and l, k<l respectively and reordering such that symbol sₖ is reordered to index l and symbol s, is reordered to index k. In FIG. 4 the pairs of symbols are consecutive so that symbols within indices 1,2,3,4,5,6 . . . are reordered to have order 2,1,4,3,6,5 . . . . The symbol modification is of the form in FIG. 3 with selection of the complex conjugate for all symbols and phase rotations which alternate between 0 and 180 degrees. The digital modulation symbols 410 are mapped to the first spatial transmission layer 402 while the reordered digital modulation symbols 408 are mapped to the second transmission layer 404. Both the original set of modulation symbols and its reordered and phase rotated version is transmitted in the same SC-FDMA symbol interval.

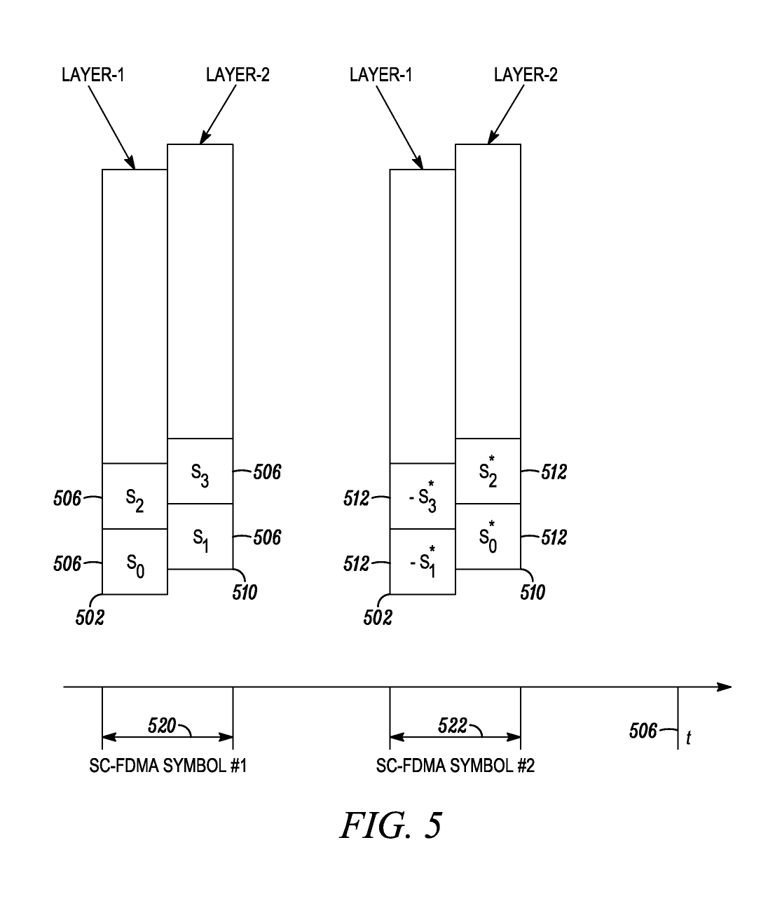

FIG. 5 illustrates another embodiment of the disclosure where the same reordering and phase factors used in the embodiment of FIG. 4 are used. In this embodiment however the original vector 218 of complex-valued modulation symbols are first split into two vectors [symbol] ₀ S₂ L S_{N-2} [symbol] and [symbol] ₁ s₃ L S_{N-1} [symbol] where N assumed to be even . Space transform coding 118 described above is applied to each of these vectors separately. The processing of [symbol] ₀ s₂ L S_{N-2} [symbol] will be described first. The vector 506, [symbol] ₀ s₂ L S_{N-2} [symbol] is transformed to give the vector [symbol] ₀ x₂ L x_{N-2} [symbol] which is mapped in frequency by the identity mapping to a first SC-OFDM symbol interval 520, [t₀, t₀+T). The term identity mapping refers to mapping x₀ to the first subcarrier, x₁ to a second subcarrier, and so on. The vector 506, [symbol] ₀ s₂ L S_{N-2} [symbol] is reordered as described above for the embodiment of FIG. 4: indices 0,1,2, . . . N−1 are reordered to 1,0,3,2, . . . ,N−1,N−2. The symbol modification step used is that described in FIG. 3 where the selector selects the complex conjugate for all symbols and no rotation in phase is performed. The results of the symbol modification step is the set of complex-valued modulation symbols 512 which are mapped to the second layer at a second SC-OFDM symbol interval 522, [t₁, t₁+T). As with the first set of complex-valued modulation symbols, the frequency mapping is the identity mapping.

A similar sequence of steps as described above is used to perform space transform coding on the vector, [symbol] ₁ s₃ L s_{N-1}

[symbol]

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is

1. A method for a wireless communication device to transmit in a multi-layer Single-Carrier Frequency Division Multiple Access (SC-FDMA) system, the method comprising:
obtaining a first block of complex-valued symbols by transforming a first vector set of digital modulation symbols with a Discrete Fourier Transformation, wherein each digital modulation symbol corresponds to a unique transform code;
mapping the first block of complex-valued symbols onto a set of FDMA frequency resources of a first spatial layer in a first SC-FDMA symbol period;
obtaining a second vector of digital modulation symbols based on at least re-ordering the first vector of digital modulation symbols;
obtaining a second block of block of complex-valued symbols by transforming the second vector of digital modulation symbols with a Discrete Fourier Transformation; and
mapping the second block of complex-valued symbols onto a set of FDMA frequency resources of a second spatial layer in a second FDMA symbol period.

2. The method of claim 1, wherein each digital modulation symbol of both the first and second vectors corresponds to a unique transform code, the transform code depends on the position of the digital modulation symbol in the corresponding vector.

3. The method of claim 1, wherein obtaining the second vector of digital modulation symbols based on at least re-ordering the first vector of digital modulation symbols further comprises mapping at least one symbol in the first vector onto a different position in the second vector so that the corresponding transform code is distinct for the at least one symbol.

4. The method of claim 1, obtaining the second vector of digital modulation symbols further comprises:
pairing two digital modulation symbols of the first vector of digital modulation symbols to obtain a set of pairs;
reversing an order of the two symbols in each pair.

5. The method of claim 4, further comprising:
conjugating one symbol in each symbol pair;
conjugating and negating the other symbol in each symbol pair.

6. The method of claim 1, wherein obtaining the second vector of digital modulation symbols further comprises:
modifying one or more digital modulation symbols of the first vector of digital modulation symbols by at least conjugating and rotating a phase.

7. The method of claim 1, the first spatial layer in the first SC-FDMA symbol period and the second spatial layer in the second SC-FDMA symbol period correspond to the different spatial layers in the same symbol period.

8. The method of claim 1, the first spatial layer in the first SC-FDMA symbol period and the second spatial layer in the second SC-FDMA symbol period correspond to the same spatial layer in two different symbol periods.

9. The method of claim 1, the first spatial layer in the first SC-FDMA symbol period and the second spatial layer in the second SC-FDMA symbol period correspond to different spatial layers in two different symbol periods.

10. The method of claim 1, the frequency resources of the first spatial layer are the same as the frequency resources of the second spatial layer.

11. The method of claim 1, wherein mapping the first block of complex-valued symbols onto the set of SC-FDMA frequency resources of the first spatial layer and mapping the second block of complex-valued symbols onto the set of SC-FDMA frequency resources of the second spatial layer further comprises:
precoding the first and second blocks of complex-valued symbols according to a weighting indicated by a control message.

12. A wireless communication device configured to transmit in a multi-layer Single-Carrier Frequency Division Multiple Access (SC-FDMA) system, the device comprising:
a transceiver;
a controller coupled to the transceiver,
the controller configured to obtain a first block of complex-valued symbols by transforming a first vector set of digital modulation symbols with a Discrete Fourier Transformation, wherein each digital modulation symbol corresponds to a unique transform code;
the controller configured to map the first block of complex-valued symbols onto a set of FDMA frequency resources of a first spatial layer in a first FDMA symbol period;
the controller configured to obtain a second vector of digital modulation symbols based on at least re-ordering the first vector of digital modulation symbols;
the controller configured to obtain a second block of block of complex-valued symbols by transforming the second vector of digital modulation symbols with a Discrete Fourier Transformation; and
the controller configured to map the second block of complex-valued symbols onto a set of SC-FDMA frequency resources of a second spatial layer in a second SC-FDMA symbol period.

13. The device of claim 12, wherein each digital modulation symbol of both the first and second vectors corresponds to a unique transform code, the transform code depends on the position of the digital modulation symbol in the corresponding vector of symbols.

14. The device of claim 12, wherein the controller is configured to obtain the second vector of digital modulation symbols based on at least re-ordering the first vector of digital modulation symbols by mapping at least one symbol in the first vector onto a different position in the second vector so that the corresponding transform code is distinct for the at least one symbol.

15. The device of claim 12, the controller configured to obtain the second vector of digital modulation symbols by pairing two digital modulation symbols of the first vector of digital modulation symbols to obtain a set of pairs and reversing an order of the two symbols in each pair.

16. The device of claim 15, the controller further configured to conjugate one symbol in each symbol pair, and conjugate and negate the other symbol in each symbol pair.

17. The device of claim 12, the controller configured to obtain the second vector of digital modulation symbols by at least conjugating and rotating a phase of one or more digital modulation symbols of the first vector of digital modulation symbols.

18. The device of claim 12, the first spatial layer in the first FDMA symbol period and the second spatial layer in the second FDMA symbol period correspond to the different spatial layers in the same symbol period.

19. The device of claim 12, the first spatial layer in the first SC-FDMA symbol period and the second spatial layer in the second SC-FDMA symbol period correspond to the same spatial layer in two different symbol periods.

20. The device of claim 12, the first spatial layer in the first SC-FDMA symbol period and the second spatial layer in the second SC-FDMA symbol period correspond to different spatial layers in two different symbol periods.

21. The device of claim 12, the frequency resources of the first spatial layer are the same as the frequency resources of the second spatial layer.

22. The device of claim 12, the controller configured to map the first block of complex-valued symbols onto the set of SC-FDMA frequency resources of the first spatial layer and map the second block of complex-valued symbols onto the set of SC-FDMA frequency resources of the second spatial layer by:
precoding the first and second blocks of complex-valued symbols according to a weighting indicated by a control message.

23. A method for a wireless base unit to control transmission from a wireless device in a multi-layer Single-Carrier Frequency Division Multiple Access (SC-FDMA) system, the method comprising:
receiving, at the base unit, a vector set of digital modulation symbols from a wireless device;
the wireless base unit indicating to the wireless device to obtain a second vector set of digital modulation symbols based on at least re-ordering the first vector set of digital modulation symbols.

24. The method of claim 23 wherein the wireless base unit indicating to the wireless device to obtain a second vector of digital modulation symbols based on at least re-ordering the first vector of digital modulation symbols further comprises indicating conjugating and rotating the phase of one or more digital modulation symbols of the first vector of digital modulation symbols.

25. The method of claim 24 further comprising indicating the first spatial layer in a first SC-FDMA symbol period and the second spatial layer in a second SC-FDMA symbol period.
